(19) United States
(12) Patent Application Publication
(10) Pub. No.: US 2015/0161640 A1
(43) Pub. Date: Jun. 11, 2015

(54) SYSTEM, METHOD, AND COMPUTER-READABLE MEDIUM FOR PREDICTING TRENDS

(71) Applicant: Robert Richard Walling, III, Atlanta, GA (US)

(72) Inventor: Robert Richard Walling, III, Atlanta, GA (US)

(21) Appl. No.: 14/099,996

(22) Filed: Dec. 8, 2013

(51) Int. Cl. G06Q 30/02; G06Q 50/00

(52) U.S. Cl. CPC G06Q 30/0217; G06Q 30/0222; G06Q 50/01

(57) ABSTRACT

A method, comprising providing, by a computing device, one or more credits to a user; receiving, by the computing device, a selection for an object; determining, by the computing device, a value for the selected object based on one or more metrics; providing, by the computing device, the value to the user; accepting, by the computing device, a bid for one or more shares of the object from the user if a cost associated with the bid is less than or equal to the credits, wherein the cost is based on at least the determined value and the one or more shares; deducting, by the computing device, the cost from the credits; and adding, by the computing device, the one or more shares of the object to a portfolio associated with the user.

### SUMMARY OF THE INVENTION

A method, comprising providing, by a computing device, one or more credits to a user; receiving, by the computing device, a selection for an object; determining, by the computing device, a value for the selected object based on one or more metrics; providing, by the computing device, the value to the user; accepting, by the computing device, a bid for one or more shares of the object from the user if a cost associated with the bid is less than or equal to the credits, wherein the cost is based on at least the determined value and the one or more shares; deducting, by the computing device, the cost from the credits; and adding, by the computing device, the one or more shares of the object to a portfolio associated with the user.

A method, comprising: selecting, by a computing device, an object from a portfolio associated with a user; determining, by the computing device, a value for the object based on one or more metrics; providing, by the computing device, the value to the user; selecting, by the computing device, a number of one or more shares of the object; calculating, by the computing device, a price based on at least the determined value and the selected number; adding, by the computing device, the price to a total associated with the user; and removing, by the computing device, the selected number of shares of the object from the portfolio.

A method, comprising: selecting, by a computing device, an object from a portfolio associated with a user; determining, by the computing device, a value for the object based on one or more metrics; providing, by the computing device, the value to the user; entering, by the computing device, a parameter, wherein the entered parameter is either: a number of one or more shares of the object; or a price; calculating, by the computing device, the unentered parameter based on at least the determined value and the entered parameter; adding, by the computing device, the price to a total associated with the user; and removing, by the computing device, the number of shares of the object from the portfolio.

A method, comprising: receiving, by a computing device, one or more credits; selecting, by the computing device, an object; receiving, by the computing device, a value for the object based on one or more metrics; entering, by the computing device, a parameter, wherein the entered parameter is either: a number of one or more shares of the object; or a price; calculating, by the computing device, the unentered parameter based on at least the determined value and the entered parameter; bidding, by the computing device, on the number of shares of the object if the price is less than or equal to the credits; deducting, by the computing device, the price from the credits; and adding, by the computing device, the number of shares of the object to a portfolio associated with the user.

A method, comprising: receiving, by a computing device, one or more credits; selecting, by the computing device, an object; receiving, by the computing device, a value for the object based on one or more metrics; selecting, by the computing device, a number of one or more shares of the object; calculating, by the computing device, a price based on at least the determined value and the selected number; bidding, by the computing device, on the selected number of shares of the object if the calculated price is less than or equal to the credits; deducting, by the computing device, the price from the credits; and adding, by the computing device, the number of shares of the object to a portfolio associated with the user.

A method, comprising: receiving, by a computing device, one or more credits; selecting, by the computing device, an object; receiving, by the computing device, a value for the object based on one or more metrics; selecting, by the computing device, a parameter, wherein the selected parameter is either: a number of one or more shares of the object; or a price; entering the selected parameter; calculating, by the computing device, the unselected parameter based on at least the determined value and the selected parameter; bidding, by the computing device, on the number of shares of the object if the price is less than or equal to the credits; deducting, by the computing device, the price from the credits; and adding, by the computing device, the number of shares of the object to a portfolio associated with the user.

The above described and other features are exemplified by the following figures and detailed description.

### BRIEF DESCRIPTION OF THE DRAWINGS

FIG. 1 is an exemplary embodiment of a system in accordance with the present invention.

FIG. 2 is an exemplary embodiment of a user interface in accordance with the present invention.

FIG. 3 is an exemplary embodiment of a user interface in accordance with the present invention.

FIG. 4 is an exemplary embodiment of a user interface in accordance with the present invention.

FIG. 5 is an exemplary embodiment of a user interface in accordance with the present invention.

FIG. 6 is an exemplary embodiment of a user interface in accordance with the present invention.

FIG. 7, comprising FIGS. 7A and 7B, is an exemplary embodiment of a flow diagram in accordance with the present invention.

FIG. 8, comprising FIGS. 8A and 8B, is an exemplary embodiment of a flow diagram in accordance with the present invention.

FIG. 9, comprising FIGS. 9A and 9B, is an exemplary embodiment of a flow diagram in accordance with the present invention.

FIG. 10, comprising FIGS. 10A and 10B, is an exemplary embodiment of a flow diagram in accordance with the present invention.

### DETAILED DESCRIPTION

Reference throughout this specification to “exemplary embodiment” or “one embodiment” or “an embodiment” means that a particular feature, structure, or characteristic described in connection with the embodiment is included in at least one embodiment of the present invention. Thus, appearances of the phrases “in an exemplary embodiment” or “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of user interfaces, screenshots, flow diagrams, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

“Or,” as used herein, except where noted otherwise, is inclusive, rather than exclusive. In other words, “or” is used to describe a list of alternative things in which one may choose one option or any combination of alternative options. For example, “A or B” means “A or B or both” and “A, B, or C” means “A, B, or C, in any combination.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicate use of an exclusive “or” condition. Similarly, “A, B, or C, but no combinations” and “A, B, or C, but not the combination of A, B, and C” are examples where certain combination of alternatives are not included in the choices associated with the list.

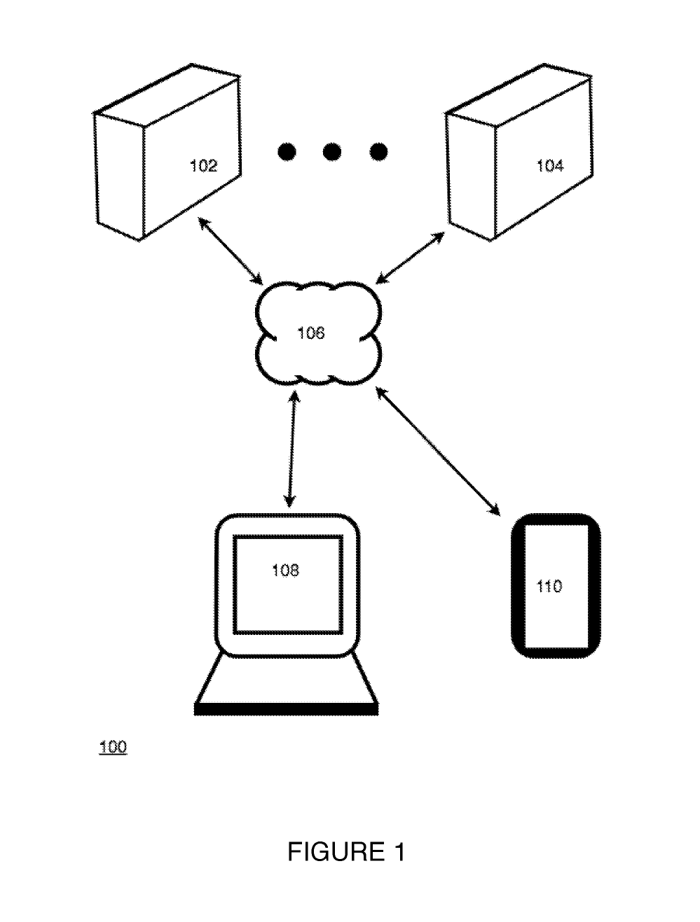

Referring now to FIG. 1, an exemplary embodiment of a system 100 capable of implementing the present invention is illustrated. A user may access portions of the present invention through, for example, a mobile computing device 110, such as a smart phone or tablet, or a conventional computing device 108, such as a laptop or desktop computer. The present invention may be implemented on software stored on a server 102, stored across multiple servers 102 and 104, stored in the cloud 106 (for example, on a cloud server), stored on a local device, such as a computing device 108 or a mobile communication device 110, or any combination of the preceding.

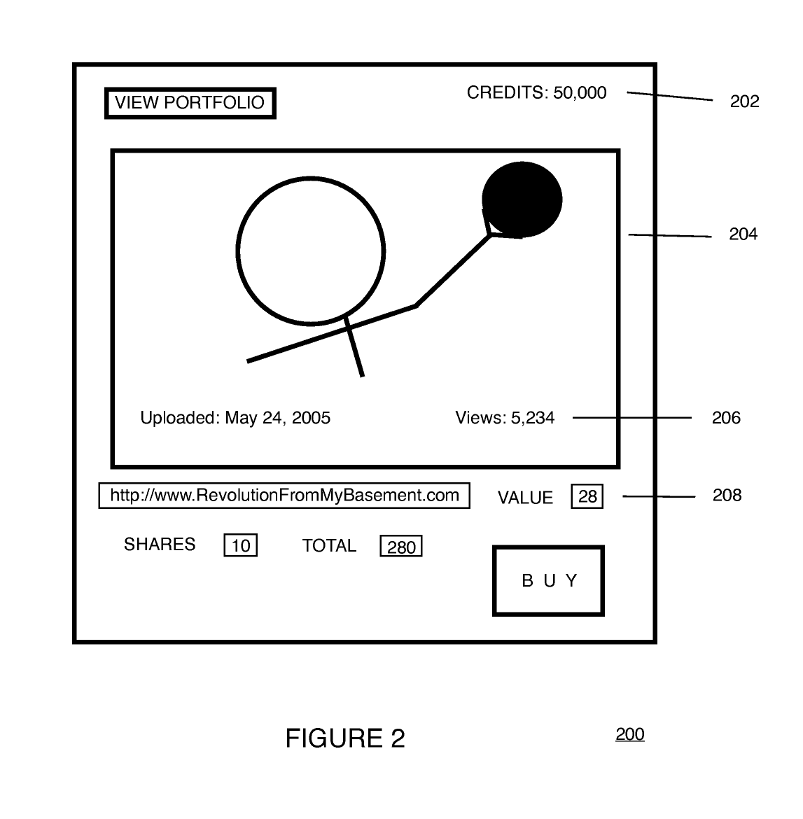

Referring now to FIG. 2, an exemplary embodiment of a user interface 200 in accordance with the present invention is illustrated. Field 202 may display a number of credits associated with a user's account. Credits may be virtual credits, currency, including crypto-currency, or any other known object suitable for representing value, either virtual or real. A user may receive credits by opening an account, clicking on a link, watching some portion or all of a video, signing up for an account on another program, asking others to participate with in a method of the present invention, other users opening accounts to participate in a method after the user sends a request, interacting with other users, including posting predictions or follow-ups on the user's or other user's profiles, including “walls,” buying credits using any currency or money or anything of value, virtual or real, consuming an advertisement, as part of a promotional offer with another product, or any other known method of providing in game advantages.

In an exemplary embodiment, an object may be bid on with the credits. An object may be any webpage, website, link, social media user, social media account, social media page, social media post, media, channel, video, picture, or any other known object accessible through a network, such as the Internet.

The object bid on may be an object found at any network address. For instance, the object may be found at a uniform resource locator (URL). The method may parse the URL to determine the type of object being bid on. For example, a URL that begins “http://www.youtube.com/watch?v” may be a video to be bid on. The method may then scrape the page at the address to obtain a representation of the object and metrics and other variables the method may use for valuation and presentation of the object. For instance, if the object is a video, representation of the object may be the actual video or a screen shot of the video 204. Other examples of representations of the object, may be the actual object itself, which may be the case, for example, for pictures or posts. In other exemplary embodiments, the representation may be, for example, a profile picture, which may be the case, for example, for social media accounts or posts. Any other known representation for an object may be used. In an exemplary embodiment, when the object is a video, metrics may be, for instance, a view count 206. Other examples of metrics are described below. In an exemplary embodiment, when the object is a video, other variables used for valuation may be, for example, a date the video was uploaded. Other examples of variables are described below.

Examples of metrics may be, for example, a number of times media has been accessed, including a number of times a video or webpage has been viewed; a number of times media has received feedback, such as comments; a number of times media has received positive feedback, including a number of times a video or link has been “liked” or “voted up,” or received a “thumbs up;” a number of times media has received negative feedback, including a number of times a video or link has been “disliked” or “voted down,” or received a “thumbs down;” a number of accounts associated with an entity, including a number of “likes,” “fans,” “followers,” “connections,” “subscribers,” “votes,” or “views” a “page,” “site,” “link,” or “channel” has; a number of times a message has been shared, including a number of “retweets,” “shares,” or “reposts” a “message,” “post,” or “tweet” has; a number of entities that have linked to the object; a position on a list, such as a “trending” topics list; a number of entities that have picked the object as a “trending” topic; or any other known object suitable for measuring the popularity of an object. One entity may also serve as the definitive judge in an exemplary embodiment. For instance, the entity may decide what is “trending.”

A value 208 may be the result of any formula with any metric used to value an object in a meaningful way. For example, an exemplary formula may include any metric divided by the time since the object was uploaded, posted, or created. The time may be measure in any increment of time, including one or more seconds, minutes, hours, days, weeks, months, years or fractions thereof, or any combination thereof. An exemplary formula may consider the total number of shares outstanding of the object. An exemplary formula may consider the total number of shares owned by all users or a subset of all users within one or more logical networks. An exemplary formula may consider historic values of the objects, including the values at which users have purchased shares of the object. In an exemplary formula, the value may simply be a position in a list, such as a “trending” topics list.

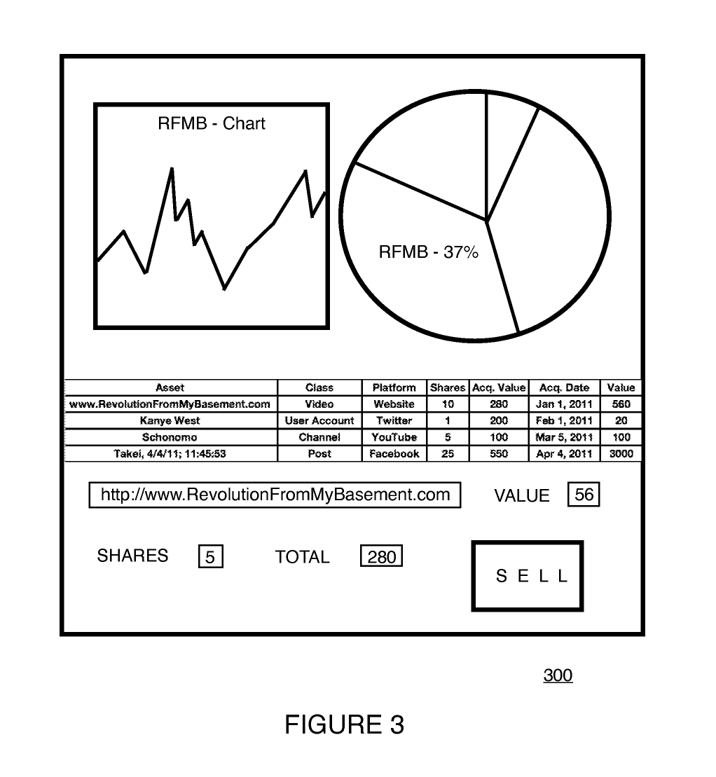

Referring now to FIG. 3, an exemplary embodiment of a user interface 300 in accordance with the present invention is illustrated. A portfolio associated with a user account may be displayed by the user interface. Individual objects within the portfolio may be displayed. For instance, an individual object's performance with respect to time may be displayed, for example, in a line graph. Additionally, an individual object's performance in relationship to the rest of the object's in a portfolio may be displayed, for example, in a pie chart or spreadsheet. Any other known method of displaying objects in a portfolio may be used.

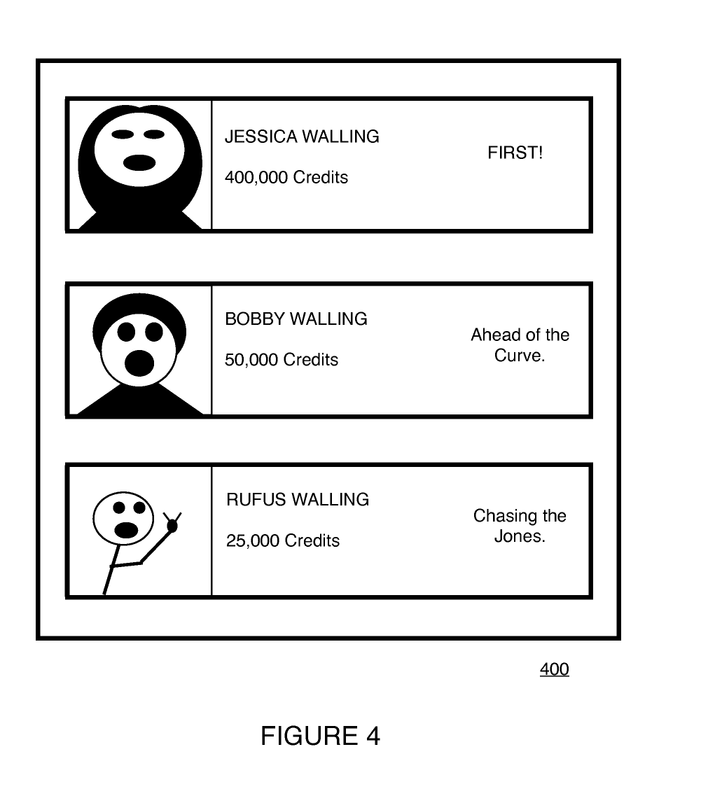

Referring now to FIG. 4, an exemplary embodiment of a user interface 400 in accordance with the present invention is illustrated. The method may rank users based on the performance of the objects in their account. The method may also rank users based on the credits associated with the users. Rankings may also be based on the performance of one or more objects in the portfolio of the users. Rankings may be generated at regular time intervals, such as daily or weekly. Rankings may also be generated “on-demand” at the request of a user. Rankings may be based on all users of the method. Rankings may also be based on a subset of all users within one or more logical networks; for instance, the rankings displayed to a particular user may include all of the users with an association with the user (for example, the ranking includes all of the users' “friends”).

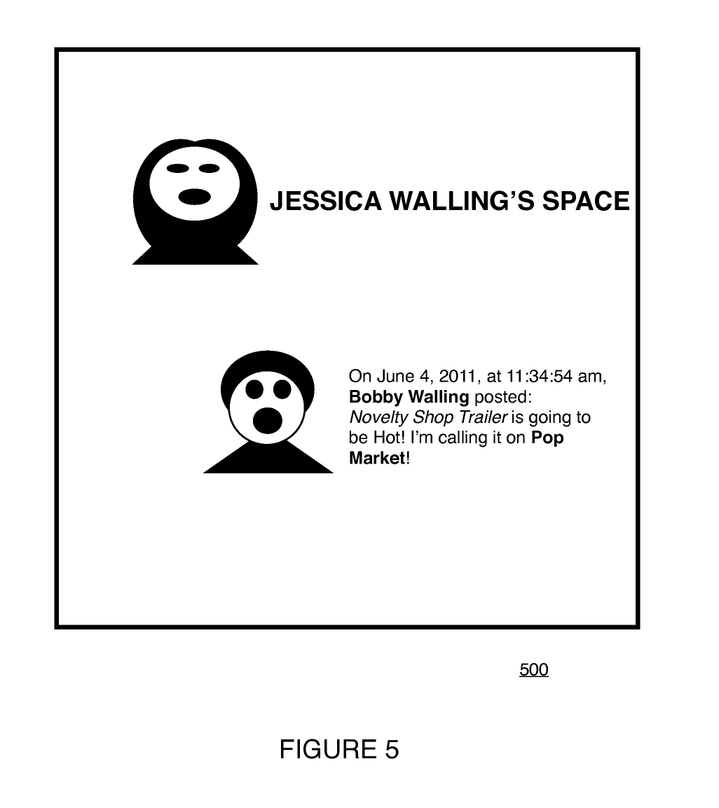

Referring now to FIG. 5, an exemplary embodiment of a user interface 500 in accordance with the present invention is illustrated. The method may allow a user to post or broadcast a prediction. In an exemplary embodiment, a user may post a prediction to the user's profile, account, “wall,” or any “space” associated with the user. In an exemplary embodiment, a user may post a prediction to another user's or group of user's profile, account, “wall,” or any “space” associated with the other user or group of users.

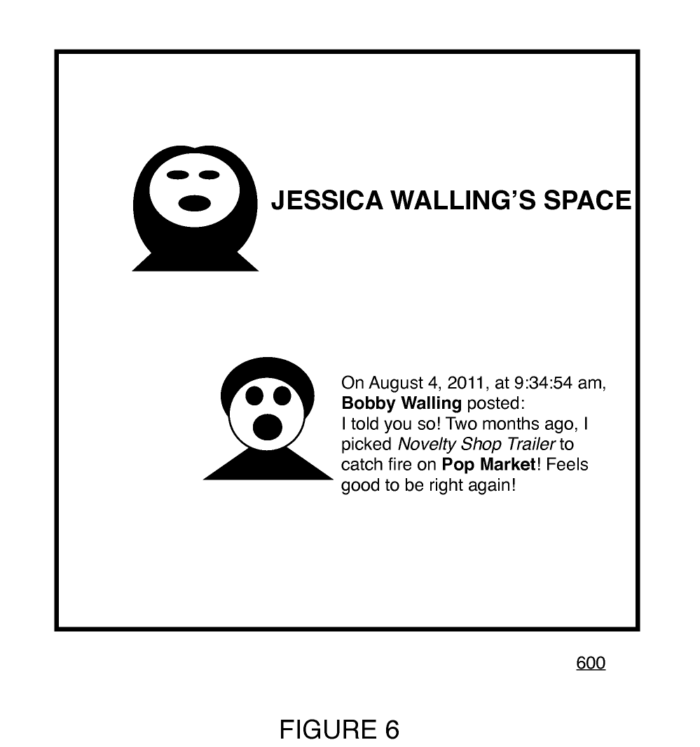

Referring now to FIG. 6, an exemplary embodiment of a user interface 600 in accordance with the present invention is illustrated. The method may allow a user to post or broadcast a boast. In an exemplary embodiment, a user may post a boast to the user's profile, account, “wall,” or any “space” associated with the user. In an exemplary embodiment, a user may post a boast to another user's or group of user's profile, account, “wall,” or any “space” associated with the other user or group of users. In an exemplary embodiment, the boast may refer back to a previous prediction. In an exemplary embodiment, the boast may refer to a ranking. In an exemplary embodiment, the boast may refer to one or more of the objects in the user's portfolio. In an exemplary embodiment, the boast may refer to the user's credits.

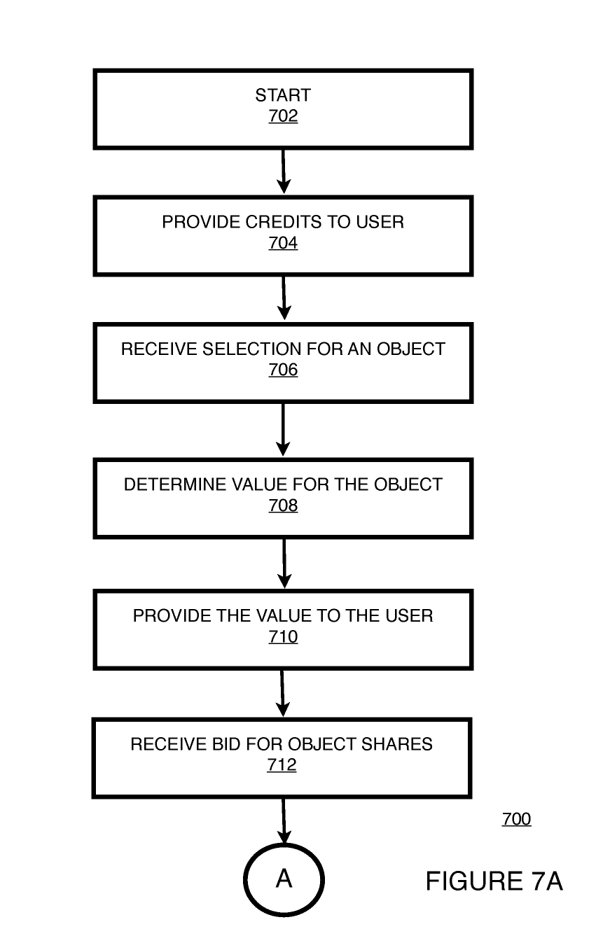

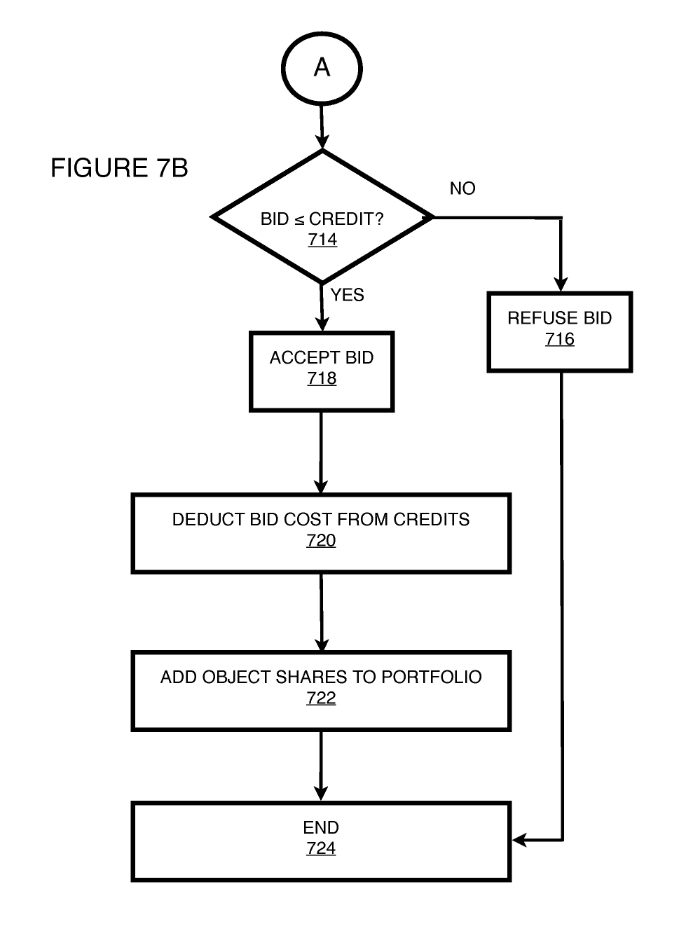

Referring now to FIGS. 7A and 7B, an exemplary embodiment of a flow diagram in accordance with the present invention is illustrated. At step 702, the method starts. In an exemplary embodiment, a user may create an account or log into an existing account to start 702 method 700. In an exemplary embodiment, a user may click a button or any other known method for invoking events in software to start 702 method 700. At step 704, a plurality of credits is provided to a user account. At step 706, a selection for an object is received. At step 708, a value for the selected object is determined. At step 710, the determined value is provided to the user. At step 712, a bid for one or more shares of the object at the determined value per share is received. At step 714, the method determines if the bid for the shares is less than or equal to the total number of credits associated with the user's account. If the bid exceeds the total number of credits, then the bid is refused at step 716 and the method ends at step 724. If the bid is less than or equal to the user's total credits, then the method continues to step 718 where the bid is accepted. At step 720, the cost of the bid is deducted from the credits associated with the user. At step 722, the shares of the object are added to a portfolio associated with the user. At step 724, the method ends.

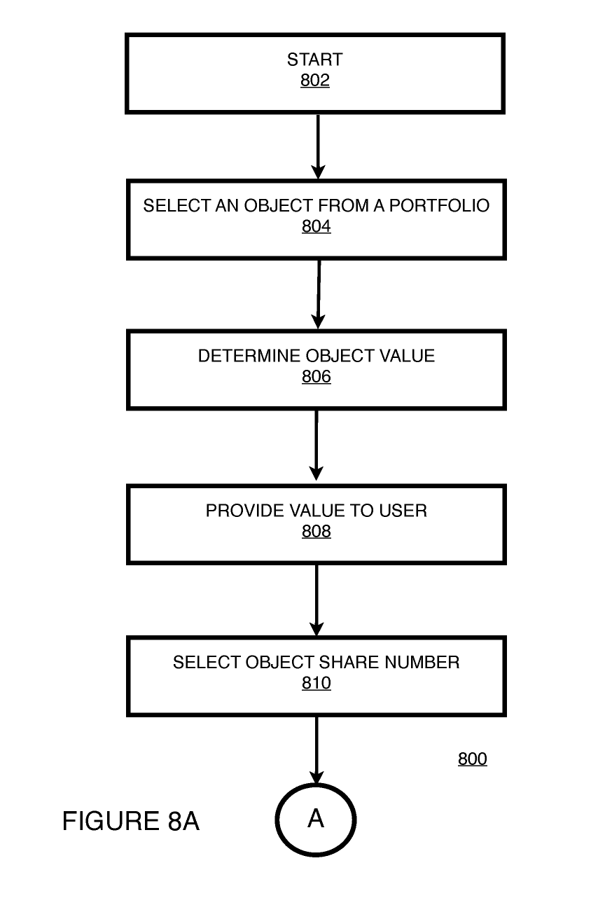

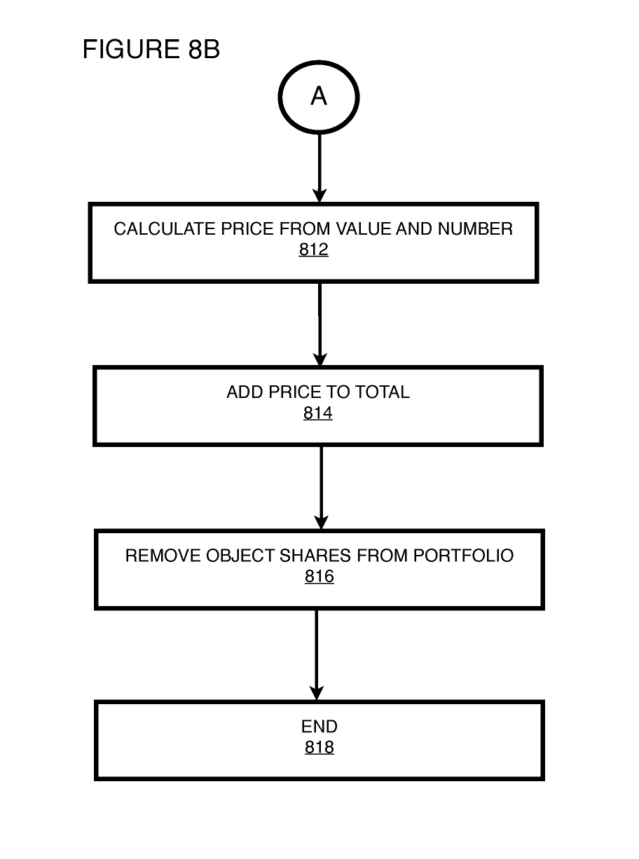

Referring now to FIGS. 8A and 8B, an exemplary embodiment of a flow diagram in accordance with the present invention is illustrated. At step 802, the method starts. In an exemplary embodiment, a user may create an account or log into an existing account to start 802 method 800. In an exemplary embodiment, a user may click a button or any other known method for invoking events in software to start 802 method 800. At step 804, an object is selected from a portfolio. At step 806, the selected object's current value is determined. At step 808, the determined value is provided to a user. At step 810, a number of shares of the object is selected. At step 812, a price is calculated from the determined value and selected number of shares. At step 814, the calculated price is added to a total associated with the user. At step 816, the selected number of shares of the object is removed from a portfolio associated with a user. At step 818, the method ends.

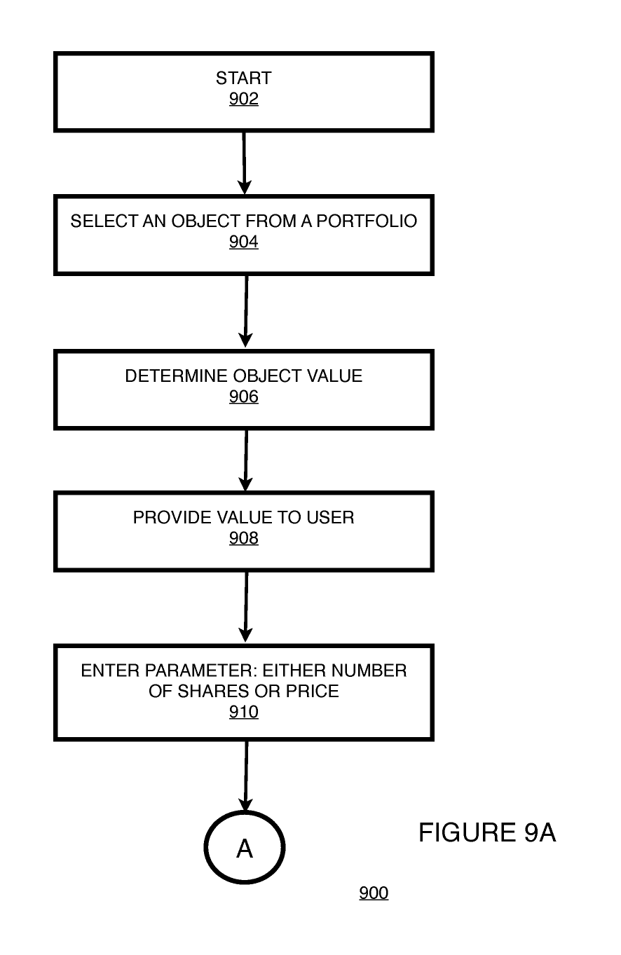

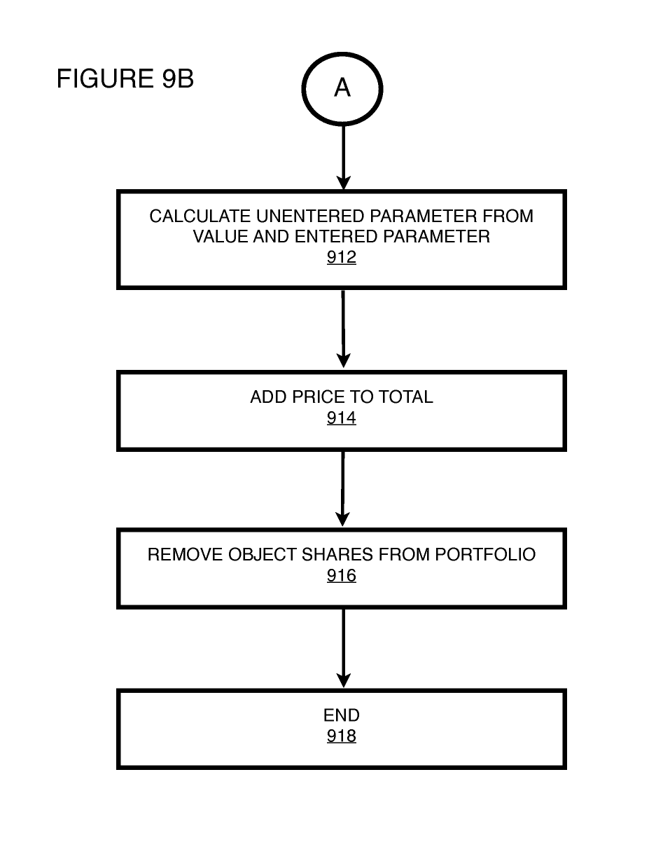

Referring now to FIGS. 9A and 9B, an exemplary embodiment of a flow diagram in accordance with the present invention is illustrated. At step 902, the method starts. In an exemplary embodiment, a user may create an account or log into an existing account to start 902 method 900. In an exemplary embodiment, a user may click a button or any other known method for invoking events in software to start 902 method 900. At step 904, an object is selected from a portfolio. At step 906, the selected object's current value is determined. At step 908, the determined value is provided to a user. At step 910, a parameter is entered. The entered parameter may be either a number of shares of the selected object or a price. If the entered parameter is a number of shares, then a price is calculated at step 912 from the determined value and and the entered number of shares. If the entered parameter is a price, then a number of shares is calculated at step 912 from the determined value and the entered price. At step 914, the price is added to a total associated with the user. At step 916, the number of shares of the object is removed from a portfolio associated with a user. At step 918, the method ends.

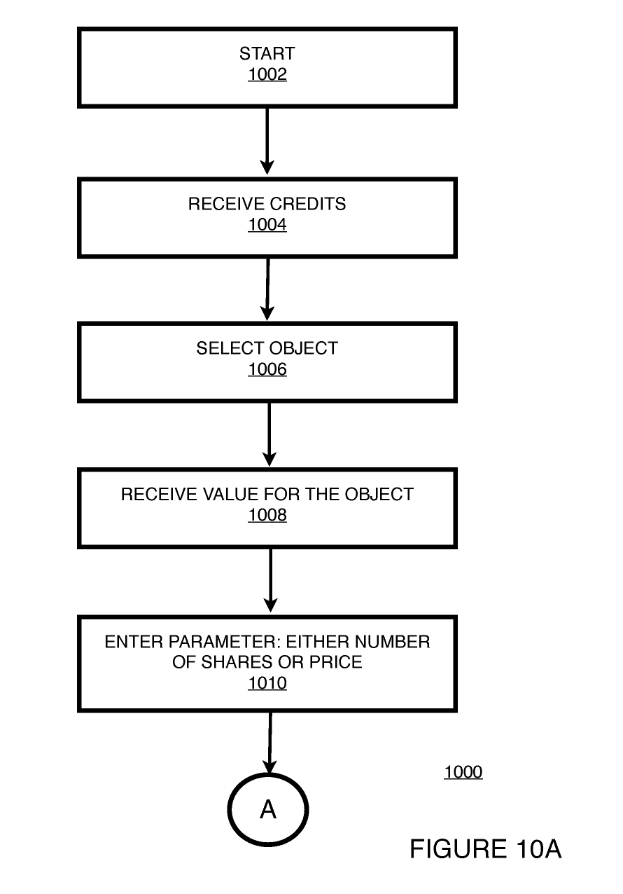

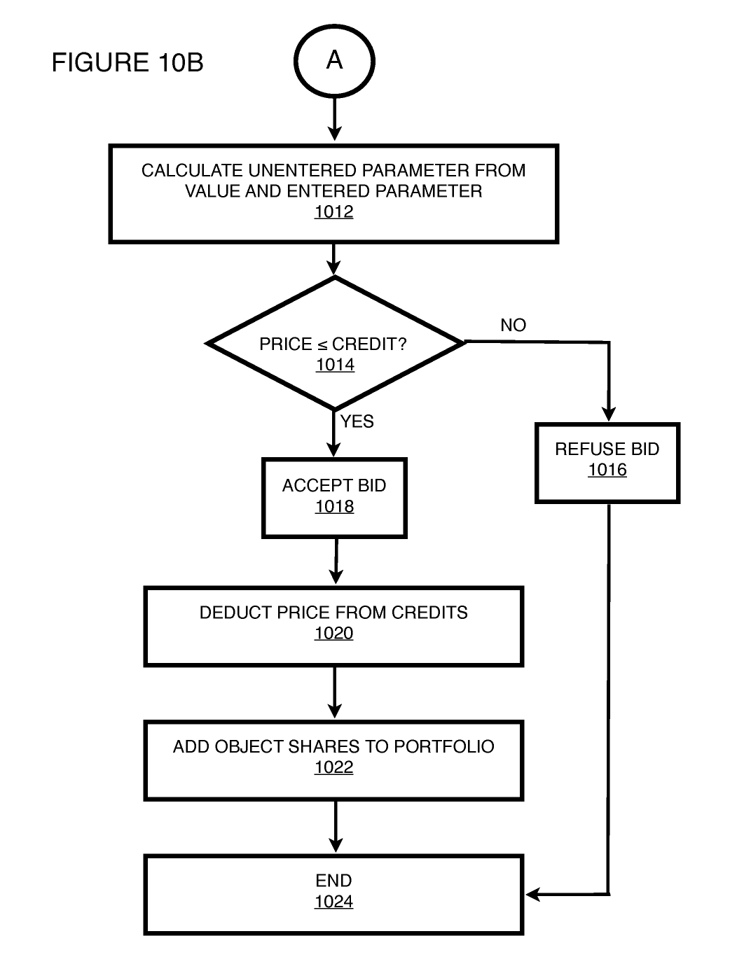

Referring now to FIGS. 10A and 10B, an exemplary embodiment of a flow diagram in accordance with the present invention is illustrated. At step 1002, the method starts. In an exemplary embodiment, a user may create an account or log into an existing account to start 1002 method 1000. In an exemplary embodiment, a user may click a button or any other known method for invoking events in software to start 1002 method 1000. At step 1004, a plurality of credits are received. At step 1006, an object is selected. At step 1008, a value for the object is received. At step 1010, a parameter is entered. The entered parameter may be either a number of shares of the selected object or a price. If the entered parameter is a number of shares, then a price is calculated at step 1012 from the determined value and and the entered number of shares. If the entered parameter is a price, then a number of shares is calculated at step 1012 from the determined value and the entered price. At step 1014, the method determines if the price is less than or equal to the received credits. If the price exceeds the credits, then a purchase for the shares of the object at the price does not go through (or the bid is refused) at step 1016 and the method ends at step 1024. If the price is less than or equal to the credits, then the method continues to step 1018 where a purchase for the number of shares of the object at the price does go through (or the bid is accepted). At step 1020, the price is deducted from the credit. At step 1022, the number of shares of the object are added to a portfolio associated with the user. At step 1024, the method ends.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus, including smart phones and other mobile devices, adapted for carrying out the methods described herein is suited. A typical combination of hardware and software with a computer system with a computer program that, when being loaded and executed, controls the computer system such that it carries out the methods described herein. Another typical combination may be a general-purpose computer system with a computer program that, when being loaded and executed, controls the computer system such that it carries out the methods described herein. Another typical combination may be both a mobile communication device with a computer system with a computer program that, when being loaded and executed, controls the computer system such that it carriers out the methods described herein and a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
providing, by a computing device, one or more credits to a user;
receiving, by the computing device, a selection for an object;
determining, by the computing device, a value for the selected object based on one or more metrics;
providing, by the computing device, the value to the user;
accepting, by the computing device, a bid for one or more shares of the object from the user if a cost associated with the bid is less than or equal to the credits, wherein the cost is based on at least the determined value and the one or more shares;
deducting, by the computing device, the cost from the credits; and adding, by the computing device, the one or more shares of the object to a portfolio associated with the user.

2. The method of claim 1, wherein the object is media made available on the Internet.

3. The method of claim 1, wherein the object is video made available through social media.

4. The method of claim 1, wherein the object is a user of social media.

5. The method of claim 1, wherein the object is a channel made available on the Internet.

6. The method of claim 1, wherein the object is a page made available on the Internet.

7. The method of claim 1, wherein the one or more metrics comprises a number of people that have consumed the object.

8. The method of claim 1, wherein the one or more metrics comprises a number of people associated with the object.

9. The method of claim 1, wherein the one or more metrics comprises a number of people with an interaction with the object.

10. The method of claim 1, wherein the one or more metrics comprises a number of people with a negative interaction with the object.

11. The method of claim 1, wherein the one or more metrics comprises a number of people with a positive interaction with the object.

12. The method of claim 1, wherein the one or more metrics comprises a period of time that the object has been available.

13. The method of claim 1, wherein the one or more metrics comprises a number of days that the object has been available.

14. The method of claim 1, wherein the value is based on at least a number of people associated with the object divided by a number of days the object has been available.

15. A method, comprising:
selecting, by a computing device, an object from a portfolio associated with a user;
determining, by the computing device, a value for the object based on one or more metrics;
providing, by the computing device, the value to the user;
selecting, by the computing device, a number of one or more shares of the object;
calculating, by the computing device, a price based on at least the determined value and the selected number;
adding, by the computing device, the price to a total associated with the user; and
removing, by the computing device, the selected number of shares of the object from the portfolio.

16. The method of claim 15, wherein the object is media made available on the Internet.

17. The method of claim 15, wherein the object is video made available through social media.

18. The method of claim 15, wherein the object is a user of social media.

19. The method of claim 15, wherein the object is a channel made available on the Internet.

20. A method, comprising:
receiving, by a computing device, one or more credits;
selecting, by the computing device, an object;
receiving, by the computing device, a value for the object based on one or more metrics;
entering, by the computing device, a parameter, wherein the entered parameter is either:
a number of one or more shares of the object; or
a price;
calculating, by the computing device, the unentered parameter based on at least the determined value and the entered parameter;
bidding, by the computing device, on the number of shares of the object if the price is less than or equal to the credits;
deducting, by the computing device, the price from the credits; and
adding, by the computing device, the number of shares of the object to a portfolio associated with the user.
